(19) United States
(12) Patent Application Publication
(10) Pub. No.: US 2021/0086550 A1
(43) Pub. Date: Mar. 25, 2021

(54) AIRCRAFT SAFETY WARNING DECAL

(71) Applicant: Bell Textron Inc., Fort Worth, TX (US)

(72) Inventor: Min Young Yoo, Fort Worth, TX (US)

(21) Appl. No.: 16/586,605

(22) Filed: Sep. 27, 2019

Related U.S. Application Data
(63) Continuation of application No. 29/706,730, filed on Sep. 23, 2019, now Pat. No. D906848.
Application No. 29/706,730 is a continuation of application No. 29/706,734, filed on Sep. 23, 2019, now Pat. No. D906849.
Application No. 29/706,734 is a continuation of application No. 29/706,737, filed on Sep. 23, 2019, now Pat. No. D906850.
Application No. 29/706,737 is a continuation of application No. 29/706,742, filed on Sep. 23, 2019, now Pat. No. D906851.

(51) Int. Cl. B44C 1/10; B64D 11/00

(52) U.S. Cl. CPC B44C 1/105; B64D 2045/007; B64D 11/00

(57) ABSTRACT

One embodiment is an apparatus comprising a transparent film having adhesive material disposed on a first planar surface thereof and a design imprinted on a second planar surface thereof, wherein the second planar surface is opposite the first planar surface and wherein the design comprises a plurality of graphical elements each having an outline therearound in a color that contrasts with a color of the element.

### CROSS-REFERENCE TO RELATED APPLICATIONS

This application is a continuation and claims the benefit of priority under 35 U.S.C. § 120 of U.S. Design patent application Ser. No. 29/706,730 (Atty. Docket No. 2355-0105-A (D-051)), filed on Sep. 23, 2019, entitled “SAFETY WARNING DECAL,” U.S. Design patent application Ser. No. 29/706,734 (Atty. Docket No. 2355-0105-B (D-052)), filed on Sep. 23, 2019, entitled “SAFETY WARNING DECAL,” U.S. Design patent application Ser. No. 29/706,737 (Atty. Docket No. 2355-0105-C (D-053)), filed on Sep. 23, 2019, entitled “SAFETY WARNING DECAL,” and U.S. Design patent application Ser. No. 29/706,742 (Atty. Docket No. 2355-0105-D (D-054)), filed on Sep. 23, 2019, entitled “SAFETY WARNING DECAL.” The disclosures of the prior applications are considered part of and are incorporated by reference in their entireties into the present disclosure.

### TECHNICAL FIELD

This disclosure relates in general to the field of aircraft and, more particularly, though not exclusively, to a safety warning decal for aircraft.

### BACKGROUND

Vehicles used for public transportation, including aircraft, often include in the interior thereof safety warning signs advising passengers of activities that should be specifically performed or avoided under certain conditions and in certain circumstances. Such warning signs may include information presented as written instructions, graphic illustrations, or both. In cases where the vehicle is mass produced, the warning signs may be printed on decals that may be applied to the interior of the vehicle in conspicuous locations, which may vary from vehicle to vehicle.

### SUMMARY

One embodiment is an apparatus comprising a transparent film having adhesive material disposed on a first planar surface thereof and a design imprinted on a second planar surface thereof, wherein the second planar surface is opposite the first planar surface and wherein the design comprises a plurality of graphical elements each having an outline therearound in a color that contrasts with a color of the element.

Another embodiment is an apparatus for installation in a vehicle, the apparatus comprising a transparent label having a design imprinted on a front surface thereof, wherein the design comprises a plurality of non-textual graphical elements, wherein each of the non-textual graphical elements is surrounded by an outline and wherein a color of the outline contrasts with a color of the non-textual graphical element.

Yet another embodiment is an aircraft comprising a passenger compartment including an interior wall and a decal affixed to the interior wall, the decal comprising a transparent film having adhesive material disposed on a first planar surface thereof and a design imprinted on a second planar surface thereof, wherein the second planar surface is opposite the first planar surface and wherein the design comprises a plurality of graphical elements each having an outline therearound in a color that contrasts with a color of the element.

### BRIEF DESCRIPTION OF THE DRAWINGS

To provide a more complete understanding of the present disclosure and features and advantages thereof, reference is made to the following description, taken in conjunction with the accompanying figures, in which like reference numerals represent like elements:

FIG. 1 illustrates an aircraft in which embodiments of a safety warning decal described herein may be implemented according to the present disclosure;

FIGS. 2A and 2B illustrate one embodiment of a safety warning decal according to the present disclosure;

FIGS. 3A and 3B illustrate an alternative embodiment of a safety warning decal according to the present disclosure; and

FIGS. 4A and 4B illustrate another alternative embodiment of a safety warning decal according to the present disclosure.

### DETAILED DESCRIPTION

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

Additionally, as referred to herein in this Specification, the terms “forward”, “aft”, “inboard”, and “outboard” may be used to describe relative relationship(s) between components and/or spatial orientation of aspect(s) of a component or components. The term “forward” may refer to a spatial direction that is closer to a front of an aircraft relative to another component or component aspect(s). The term “aft” may refer to a spatial direction that is closer to a rear of an aircraft relative to another component or component aspect(s). The term “inboard” may refer to a location of a component that is within the fuselage of an aircraft and/or a spatial direction that is closer to or along a centerline of the aircraft (wherein the centerline runs between the front and the rear of the aircraft) or other point of reference relative to another component or component aspect. The term “outboard” may refer to a location of a component that is outside the fuselage of an aircraft and/or a spatial direction that farther from the centerline of the aircraft or other point of reference relative to another component or component aspect.

Further, the present disclosure may repeat reference numerals and/or letters in the various examples. This repetition is for the purpose of simplicity and clarity and does not in itself dictate a relationship between the various embodiments and/or configurations discussed. Example embodiments that may be used to implement the features and functionality of this disclosure will now be described with more particular reference to the accompanying FIGURES.

Described herein is a blade root bearing carrier assembly that includes integrated bearing separators and a shield. In particular, the integrated separators retain and space the ball bearings, while the shield shields the bearings from debris and retains lubrication around the bearings. In certain embodiments, the assembly includes one or more carrier sections that include recesses for receiving ball bearings. A clearance cut at each ball receiving recess allows installation of a ball into the recess. The clearance cut is smaller than the ball diameter so that the ball snaps into place and is retained within the recess. The assembly may further include a shield to which the separators are attached, one or more handles or other features to aid handling and installation of the carriers, a linking feature to connect the carriers to one another and maintain even spacing therebetween, and lips or other features for accepting soft sealing material, such as an O-ring.

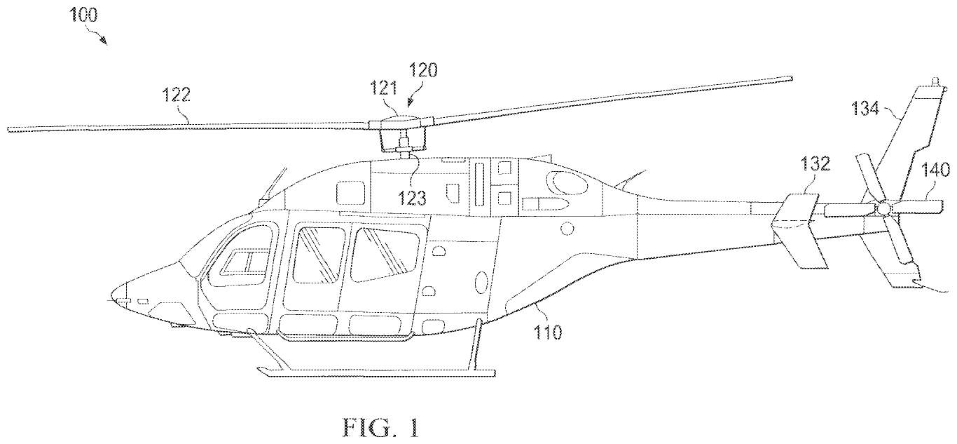

Referring to FIG. 1, illustrated therein is an example embodiment of an aircraft, which in this example is a rotorcraft 100. Rotorcraft 100 includes a fuselage 110, a rotor system 120, an empennage 130, and a tail rotor or anti-torque system 140. The fuselage 110 is the main body of the rotorcraft 100, which may include a cabin (e.g., for crew, passengers, and/or cargo) and/or may house certain mechanical components, electrical components, etc. (e.g., engine(s), transmission, flight controls, etc.). The rotor system 120 is used to generate lift for rotorcraft 100. For example, the rotor system 120 (also generally referred to as the “rotor”) may include a rotor hub 121 (also referred to as a “rotor hub assembly” or more generally as a “hub”) coupled to a plurality of rotor blades 122 (also referred to generally as “blades”). Torque generated by the engine(s) of the rotorcraft causes the rotor blades 122 to rotate, which generates lift. The rotor system 120 is supported by a mast 123. The empennage 130 of the rotorcraft 100 includes a horizontal stabilizer 132, vertical stabilizer 134, and tail rotor or anti-torque system 140. The horizontal stabilizer 132 and vertical stabilizer 134 respectively provide horizontal and vertical stability for the rotorcraft 100. Moreover, tail rotor or anti-torque system 140 may be used to provide anti-torque and/or direction control for the rotorcraft 100.

In accordance with features of embodiments described herein, safety warning decals may be provided on interior cabin walls of an aircraft, such as aircraft 100, for conveying safety information to passengers. As further described hereinbelow, the warning decals shown in the example embodiments are aesthetically pleasing, easily understood, and highly visible regardless of the color of the surface to which they are applied.

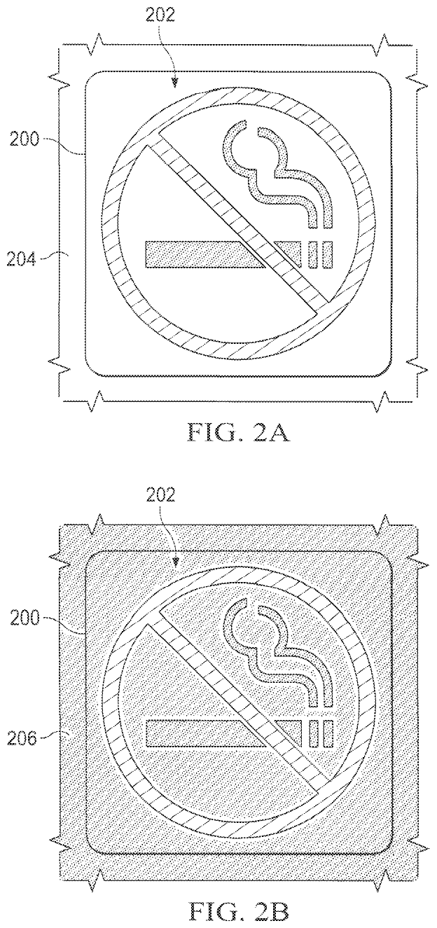

FIGS. 2A and 2B illustrate a first example embodiment of a safety warning decal, designated by a reference numeral 200. The safety warning decal 200 comprises an image 202 designed to graphically convey the instructions “No Smoking.” In accordance with features of embodiments described herein, the image 202 is reproduced on a transparent decal such that when the decal 200 is applied to a surface, such as a wall of the interior of an aircraft (e.g., aircraft 100), the image 202 appears to be printed directly on the surface itself (or at least the background of the decal is not so conspicuous as to distract from the image and/or result in an aesthetically displeasing look). Additionally, the image 202 is designed such that each graphical element thereof is outlined in a contrasting color (e.g., white) such that regardless of the color of the element (e.g., black, red, or green) or the color of the surface to which the decal 200 is applied, the image 202 remains highly visible despite the transparent background. For example, FIG. 2A illustrates the decal 200 applied to a white surface 204, while FIG. 2B illustrates the decal 200 applied to a black surface 206. In each case, all elements of the image 202 are clearly visible. Accordingly, no matter the color of the surface to which the decal 200 is applied, the image 202 will be visible due to the unique design of the image. Additionally, since the image includes no text, there is no need to provide multiple translations of the message intended to be conveyed by the decal 200 nor is there any need to produce multiple versions of the decal in cases where aircraft are produced for sale and use in a variety of countries, thereby simplifying and streamlining manufacture of the aircraft.

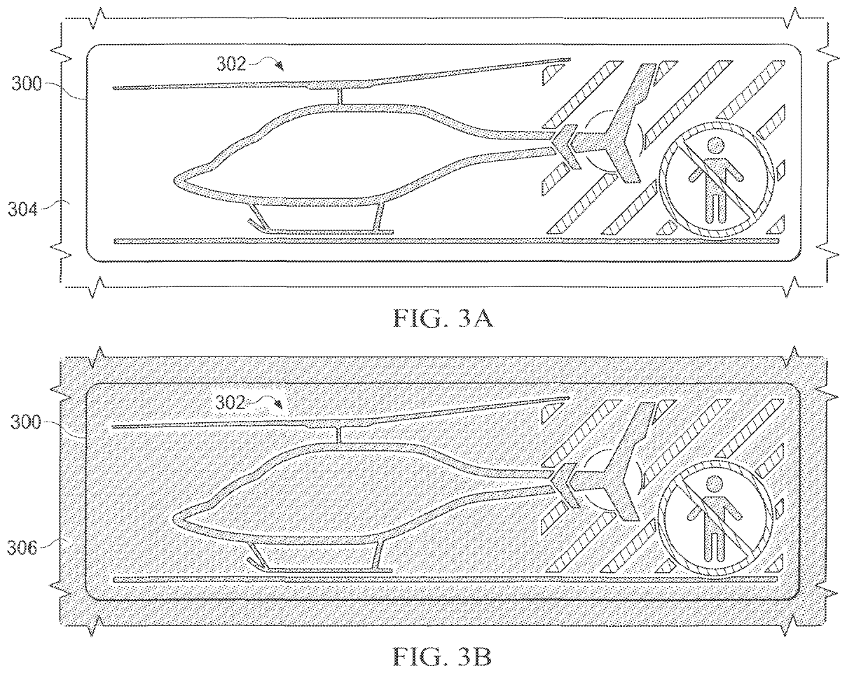

FIGS. 3A and 3B illustrate a second example embodiment of a safety warning decal, designated by a reference numeral 300. The safety warning decal 300 comprises an image 302 designed to graphically instruct passengers not to stand at the rear of the aircraft. In accordance with features of embodiments described herein, and similarly to the image 202, the image 302 is reproduced on a transparent decal such that when the decal 300 is applied to a surface, such as a wall of the interior of an aircraft (e.g., aircraft 100), the image 302 appears to be printed directly on the surface itself (or at least the background of the decal is not so conspicuous as to distract from the image and/or result in an aesthetically displeasing look). Additionally, the image 302 is designed such that each element thereof is outlined in a contrasting color (e.g., white) such that regardless of the color of the element (e.g., black, red, or green) or the color of the surface to which the decal 300 is applied, the image 302 remains highly visible despite the transparent background. For example, FIG. 3A illustrates the decal 300 applied to a white surface 304, while FIG. 3B illustrates the decal 300 applied to a black surface 306. In each case, all elements of the image 302 are clearly visible. Accordingly, no matter the color of the surface to which the decal 300 is applied, the image 302 will be visible due to the unique design of the image. Additionally, since the image includes no text, there is no need to provide multiple translations of the message intended to be conveyed by the decal 300 nor is there any need to produce multiple versions of the decal in cases where aircraft are produced for sale and use in a variety of countries, thereby simplifying and streamlining manufacture of the aircraft.

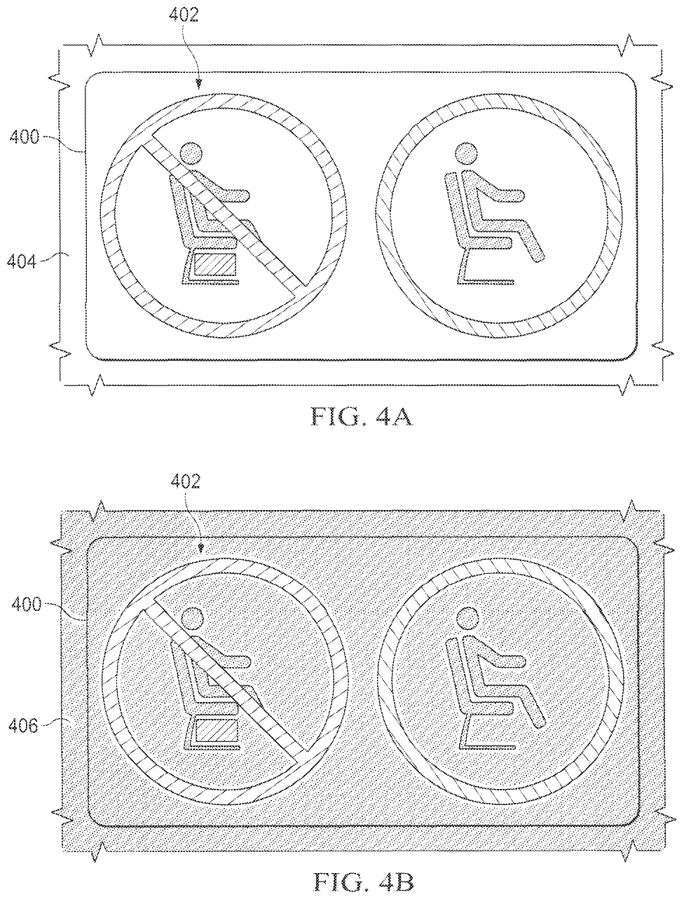

FIGS. 4A and 4B illustrate a third example embodiment of a safety warning decal, designated by a reference numeral 400. The safety warning decal 400 comprises an image 402 designed to graphically instruct passengers not to place anything underneath his or her seat. In accordance with features of embodiments described herein, and similarly to the image 202, the image 402 is reproduced on a transparent decal such that when the decal 400 is applied to a surface, such as a wall of the interior of an aircraft (e.g., aircraft 100), the image 402 appears to be printed directly on the surface itself (or at least the background of the decal is not so conspicuous as to distract from the image and/or result in an aesthetically displeasing look). Additionally, the image 402 is designed such that each element thereof is outlined in a contrasting color (e.g., white) such that regardless of the color of the element (e.g., black, red, or green) or the color of the surface to which the decal 400 is applied, the image 402 remains highly visible despite the transparent background. For example, FIG. 4A illustrates the decal 400 applied to a white surface 404, while FIG. 4B illustrates the decal 400 applied to a black surface 406. In each case, all elements of the image 402 are clearly visible. Accordingly, no matter the color of the surface to which the decal 400 is applied, the image 402 will be visible due to the unique design of the image. Additionally, since the image includes no text, there is no need to provide multiple translations of the message intended to be conveyed by the decal 400 nor is there any need to produce multiple versions of the decal in cases where aircraft are produced for sale and use in a variety of countries, thereby simplifying and streamlining manufacture of the aircraft, as well as mass production of safety warning decals for application to a surface of a variety of aircraft.

It will be noted that, although example embodiments have been described herein with reference to an aircraft, it is anticipated that the safety warning decals of the present disclosure may be applied to other types of vehicles, as well as the surface(s) of any other device(s) requiring such decals. It will be further noted that, as used herein, the term “decal” includes any sticker or label comprising a transparent film having adhesive on one side thereof for adhering to a surface and having a design imprinted or reproduced on an opposite side thereof.

At least one embodiment is disclosed, and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=Rl+k*(Ru−Rl), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

The diagrams in the FIGURES illustrate the architecture, functionality, and/or operation of possible implementations of various embodiments of the present disclosure. Although several embodiments have been illustrated and described in detail, numerous other changes, substitutions, variations, alterations, and/or modifications are possible without departing from the spirit and scope of the present disclosure, as defined by the appended claims. The particular embodiments described herein are illustrative only and may be modified and practiced in different but equivalent manners, as would be apparent to those of ordinary skill in the art having the benefit of the teachings herein. Those of ordinary skill in the art would appreciate that the present disclosure may be readily used as a basis for designing or modifying other embodiments for carrying out the same purposes and/or achieving the same advantages of the embodiments introduced herein. For example, certain embodiments may be implemented using more, less, and/or other components than those described herein. Moreover, in certain embodiments, some components may be implemented separately, consolidated into one or more integrated components, and/or omitted. Similarly, methods associated with certain embodiments may be implemented using more, less, and/or other steps than those described herein, and their steps may be performed in any suitable order.

Numerous other changes, substitutions, variations, alterations, and modifications may be ascertained to one of ordinary skill in the art and it is intended that the present disclosure encompass all such changes, substitutions, variations, alterations, and modifications as falling within the scope of the appended claims.

One or more advantages mentioned herein do not in any way suggest that any one of the embodiments described herein necessarily provides all the described advantages or that all the embodiments of the present disclosure necessarily provide any one of the described advantages. Note that in this Specification, references to various features included in “one embodiment”, “example embodiment”, “an embodiment”, “another embodiment”, “certain embodiments”, “some embodiments”, “various embodiments”, “other embodiments”, “alternative embodiment”, and the like are intended to mean that any such features are included in one or more embodiments of the present disclosure, but may or may not necessarily be combined in the same embodiments.

As used herein, unless expressly stated to the contrary, use of the phrase “at least one of”, “one or more of” and “and/or” are open ended expressions that are both conjunctive and disjunctive in operation for any combination of named elements, conditions, or activities. For example, each of the expressions “at least one of X, Y and Z”, “at least one of X, Y or Z”, “one or more of X, Y and Z”, “one or more of X, Y or Z” and “A, B and/or C” can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z. Additionally, unless expressly stated to the contrary, the terms “first”, “second”, “third”, etc., are intended to distinguish the particular nouns (e.g., blade, rotor, element, device, condition, module, activity, operation, etc.) they modify. Unless expressly stated to the contrary, the use of these terms is not intended to indicate any type of order, rank, importance, temporal sequence, or hierarchy of the modified noun. For example, “first X” and “second X” are intended to designate two X elements that are not necessarily limited by any order, rank, importance, temporal sequence, or hierarchy of the two elements. As referred to herein, “at least one of”, “one or more of”, and the like can be represented using the “(s)” nomenclature (e.g., one or more element(s)).

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph (f) of 35 U.S.C. Section 112 as it exists on the date of the filing hereof unless the words “means for” or “step for” are specifically used in the particular claims; and (b) does not intend, by any statement in the Specification, to limit this disclosure in any way that is not otherwise reflected in the appended claims.

What is claimed is:

1. An apparatus comprising a transparent film having adhesive material disposed on a first planar surface thereof and a design imprinted on a second planar surface thereof, wherein the second planar surface is opposite the first planar surface and wherein the design comprises a plurality of graphical elements each having an outline therearound in a color that contrasts with a color of the element.

2. The apparatus of claim 1, wherein the color that contrasts with a color of the graphical element is white.

3. The apparatus of claim 1, wherein the color of the graphical element comprises at least one of red, green, and black.

4. The apparatus of claim 1, wherein the apparatus is designed to be affixed to a surface of a vehicle.

5. The apparatus of claim 4, wherein the surface is an interior surface of the vehicle.

6. The apparatus of claim 4, wherein the surface is an exterior surface of the vehicle.

7. The apparatus of claim 4, wherein the vehicle comprises an aircraft.

8. The apparatus of claim 7, wherein the design communicates passenger safety information.

9. The apparatus of claim 1, wherein each of the elements is non-textual.

10. The apparatus of claim 8, wherein the passenger safety information comprises a no smoking warning.

11. The apparatus of claim 8, wherein the passenger safety information comprises a warning to avoid standing near a tail end of the aircraft.

12. The apparatus of claim 8, wherein the passenger safety information comprises a warning not to place an item underneath a seat of the aircraft.

13. An apparatus for installation in a vehicle, the apparatus comprising a transparent label having a design imprinted on a front surface thereof, wherein the design comprises a plurality of non-textual graphical elements, wherein each of the non-textual graphical elements is surrounded by an outline and wherein a color of the outline contrasts with a color of the non-textual graphical element.

14. The apparatus of claim 13, wherein the color that contrasts with a color of the non-textual graphical element is white.

15. The apparatus of claim 13, wherein the color of the non-textual graphical element comprises at least one of red, green, and black.

16. The apparatus of claim 13, wherein the vehicle comprises an aircraft.

17. The apparatus of claim 13, wherein the design communicates passenger safety information comprising at least one of a no smoking warning, a warning to avoid standing near a tail end of the aircraft, and a warning not to place an item underneath a seat of the aircraft.

18. An aircraft comprising:
a passenger compartment including an interior wall; and
a decal affixed to the interior wall, the decal comprising a transparent film having adhesive material disposed on a first planar surface thereof and a design imprinted on a second planar surface thereof, wherein the second planar surface is opposite the first planar surface and wherein the design comprises a plurality of graphical elements each having an outline therearound in a color that contrasts with a color of the element.

19. The aircraft of claim 18, wherein the color that contrasts with a color of the graphical element is white and wherein the color of the graphical element comprises at least one of red, green, and black.

20. The aircraft of claim 18, wherein the design communicates passenger safety information comprising at least one of a no smoking warning, a warning to avoid standing near a tail end of the aircraft, and a warning not to place an item underneath a seat disposed in the passenger compartment.
